(19) United States
(12) Patent Application Publication
(10) Pub. No.: US 2026/0307826 A1
(43) Pub. Date: Oct. 8, 2026

(54) USE OF A NEW TYPE OF PROPELLANT FOR ELECTRIC PROPULSION

(71) Applicant: COMMISSARIAT A L'ENERGIE ATOMIQUE ET AUX ENERGIES ALTERNATIVES, Paris (FR)

(72) Inventors: Pascal LEMAIRE, Orange (FR); Quentin Petavy, Sainte-Sigolene (FR)

(73) Assignee: COMMISSARIAT A L'ENERGIE ATOMIQUE ET AUX ENERGIES ALTERNATIVES, Paris (FR)

(21) Appl. No.: 19/489,420

(22) PCT Filed: Jun. 6, 2024
(86) PCT No.: PCT/FR2024/050736

§ 371 Date: Dec. 2, 2025

(30) Foreign Application Priority Data
Jun. 9, 2023 (FR) FR2305823

(51) Int. Cl. B64G 1/40

(52) U.S. Cl. CPC B64G 1/413

(57) ABSTRACT

Natural uranium hexafluoride, UF₆, may be used as propellant in an electric propulsion system. A method of manufacturing an electric thruster using a propellant, may include providing natural uranium hexafluoride UF₆ as the propellant in the electric thruster, optionally as the sole propellant. The electric thruster may be an electronegative thruster, a gridded electric thruster, or a Hall effect electric thruster. The method may include providing two polarized grids to generate an electric field, and/or generating an electric field by a combination of a magnetic field and an electrostatic potential difference between an anode and a cathode.

### TECHNICAL FIELD

The invention is directed to the use of a new type of propellant for electric propulsion and, in particular, space electric propulsion.

In general, propulsion relies on the exchange of momentum between an ejected material and the propulsion craft, wherein the ejected material can consist of:
hot gases resulting from an exothermic combustion reaction of a propellant comprising a fuel and an oxidant, these gases being ejected by high temperature expansion through a nozzle, this case corresponding to chemical propulsion; or
charged particles derived from a plasma generated from a propellant, energy to create the plasma and accelerate ions of this plasma for ejection being energy of electrical origin, this case thus corresponding to electric propulsion.

Electric propulsion, also known as plasma propulsion or ion propulsion, enables a high ejection speed to be achieved thanks to a separation between the energy source and the material to be ejected, which thus induces very low propellant consumption, unlike chemical propulsion. When electric propulsion is used in the space field and, more specifically, in satellite propulsion, it is thus possible to reduce mass of the propelled satellites and thus their launch cost or, in addition, to extend the duration of a mission and increase the impact thereof. In this way, despite a low level of thrust lower than with chemical propulsion, electric propulsion enables capacity and cost savings and makes it possible to carry out maneuvers and tasks that would otherwise be difficult to accomplish.

Currently, electric propulsion is mainly and operationally provided by two relatively similar technologies: gridded electric thrusters and Hall effect thrusters, these two technologies differing in how to generate the electric field at the origin of ion ejection, the electric field being generated thanks to two polarized grids for gridded electric thrusters, and being generated by the combination of a magnetic field and an electrostatic potential difference between an anode and a cathode for the Hall effect electric thrusters.

Different types of propellants can be used in these electric thrusters and in particular:
rare gases, such as xenon used mostly or even krypton or argon;
solid propellants, such as di-iodine, magnesium or zinc.

Electric propulsion can also be provided, to date but still at the prototype stage, by so-called “electronegative thrusters” which use both positive ions and negative ions for thrust, which conventionally requires the management of two propellants, one propellant capable of generating positive ions (e.g., argon) and one propellant capable of generating negative ions (e.g., sulfur hexafluoride) under a similar pressure, the use of two types of propellant, however, giving rise to an overweight that is detrimental to propulsion performance.

In view of what already exists, the inventors of the present invention have set themselves the objective of providing a new propellant that can be used efficiently in the context of electric propulsion and, more particularly, space electric propulsion, as a replacement of propellants already used in this field and, more precisely, which can be used in all types of electric thrusters, in particular in electronegative electric thrusters, without the need for two separate propellers.

### DISCLOSURE OF THE INVENTION

Thus, the invention concerns the use of natural uranium hexafluoride UF6 as propellant in an electric thruster and, more particularly, in a space electric thruster.

The term propellant can also be referred to as propellant gas.

Conventionally, natural uranium hexafluoride corresponds to uranium hexafluoride whose uranium has an isotopic composition comprising a low abundance of light isotopes, and, more specifically, between 0.6% and 0.8% of ²³⁵U. Natural uranium hexafluoride as a propellant in electric propulsion has the following advantages:
a vapor pressure with a sublimation limit at near ambient temperature and pressure;
a much better thrust at a set power, because the UF₆ gas is significantly heavier (352 g/mol) compared to xenon (131 g/mol);
temperature-only management of the density of the propelled uranium hexafluoride, because the very stable uranium hexafluoride sublimes at common temperatures, thus allowing it to be transported in crystallized form and thus no longer involving management of liquefied or cryogenic gases;
simplified ground tests with a vacuum in the test chamber obtained by cryogenic and not pumping, the management of uranium hexafluoride being well known to the person skilled in the nuclear fuel cycle;
a possibility of use in all types of electric thrusters and in particular in electronegative electric thrusters, because uranium hexafluoride is susceptible to produce both positive ions (herein, UF₅⁺) and negative ions (herein, F⁻) during the ionization process; and
the possibility of being used for all types of space flights, except those with high gravity and, in particular, for space flights intended for a change of orbit, reorientation of a satellite, interplanetary journey, objects avoiding.

The invention will now be described with regard to the following example.

### DESCRIPTION OF ONE PARTICULAR EMBODIMENT

A successful test was carried out, using natural uranium hexafluoride in a Hall-effect electric thruster with a power of approximately one kilowatt.

In addition, the particularly high ionization cross-sectional area can address the wide range of available powers of Hall effect thrusters on the market.

1. A method of manufacturing an electric thruster comprising a propellant, the method comprising:
providing natural uranium hexafluoride UF₆ as the electric thruster.

2. The method of claim 1, wherein the propellant of the electric thruster consists of the natural uranium hexafluoride UF₆, and
wherein the electric thruster is an electronegative thruster.

3. The method of claim 1, further comprising:
providing two polarized grids to generate an electric field,
wherein the electric thruster is a gridded electric thruster.

4. The method of claim 1, further comprising:
generating an electric field by a combination of a magnetic field and an electrostatic potential difference between an anode and a cathode,
wherein the electric thruster is a Hall effect electric thruster.

5. The method of claim 1, wherein the electric thruster is a space electric thruster.
